(19) United States
(12) Patent Application Publication
(10) Pub. No.: US 2021/0380036 A1
(43) Pub. Date: Dec. 9, 2021

(54) Vehicle Backseat Child Detection System

(71) Applicants: Jason Sharp, Topeka, KS (US); Jeanelle Sharp, Topeka, KS (US)

(72) Inventors: Jason Sharp, Topeka, KS (US); Jeanelle Sharp, Topeka, KS (US)

(21) Appl. No.: 16/895,445

(22) Filed: Jun. 8, 2020

(51) Int. Cl. B60Q 1/52; B60N 2/00; B60N 2/26; B60Q 3/10; B60Q 5/00

(52) U.S. Cl. CPC B60Q 1/52; B60N 2/002; B60Q 5/005; B60Q 3/10; B60N 2/26

(57) ABSTRACT

A vehicle backseat child detection system for preventing children from being left in vehicle back seats includes a control box having a timer. The control box is coupled within a dashboard of a vehicle and is in operational communication with a fuse panel and a horn of the vehicle. At least one seat pressure switch each detects the weight of a child and is in operational communication with the control box. If one seat pressure switch detects the presence of a child and the control box detects the vehicle is turned off, a warning light is activated and the timer runs for a preset duration of time before activating the horn of the vehicle unless the child is removed or the vehicle is turned on.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to vehicle safety devices and more particularly pertains to a new vehicle safety device for preventing children from being left in vehicle back seats.

### (2) Description of Related Art Including Information Disclosed Under 37 CFR 1.97 and 1.98

The prior art relates to vehicle safety devices. Existing devices have various forms of alerting a driver to a child left in the back seat, yet do not interface with the vehicle to activate the horn. Existing devices also lack a convenient deactivation system.

### BRIEF SUMMARY OF THE INVENTION

An embodiment of the disclosure meets the needs presented above by generally comprising a control box having a timer. The control box is configured to be coupled within a dashboard of a vehicle and to be in operational communication with a fuse panel and a horn of the vehicle. A warning light is in operational communication with the control box and is configured to be coupled within the dashboard of the vehicle. At least one seat pressure switch each detects the weight of a child and is in operational communication with the control box. Each seat pressure switch is configured to be placed within a seat bottom of a child seat. If one seat pressure switch detects the presence of a child and the control box detects the vehicle has been turned off, the warning light is activated and the timer runs for a preset duration of time before activating the horn of the vehicle unless the child is removed. If one seat pressure switch detects a child is placed in the child seat while the vehicle is off, the warning light is activated and the timer runs for a preset duration of time before activating the horn of the vehicle unless the vehicle is turned on.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a side elevation view of a vehicle backseat child detection system according to an embodiment of the disclosure.

FIG. 2 is a top plan view of an embodiment of the disclosure.

FIG. 3 is an isometric view of an embodiment of the disclosure.

FIG. 4 is a block diagram of an embodiment of the disclosure.

### DETAILED DESCRIPTION OF THE INVENTION

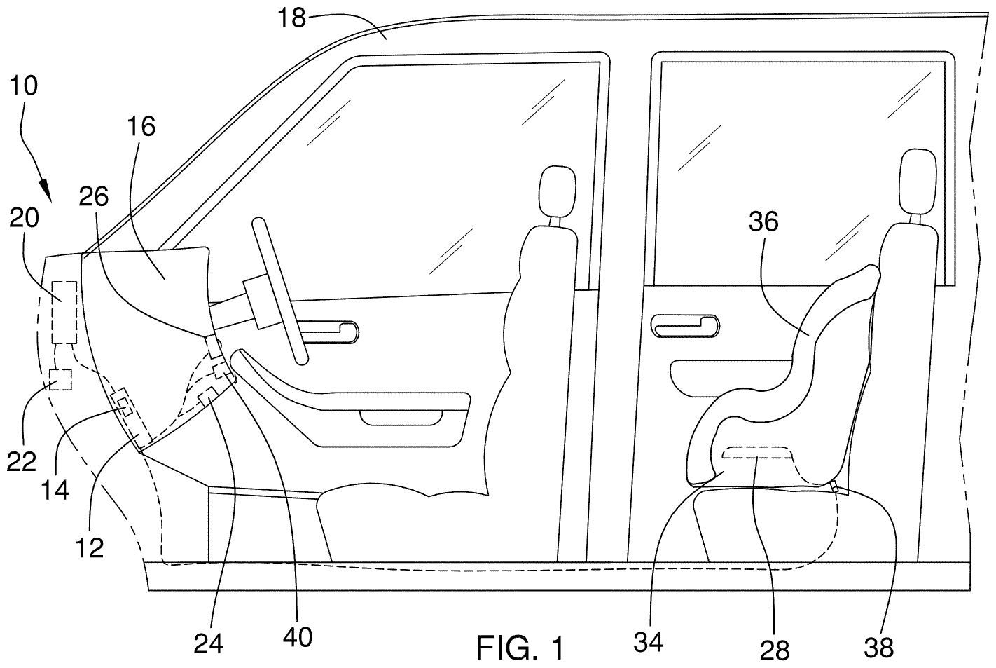

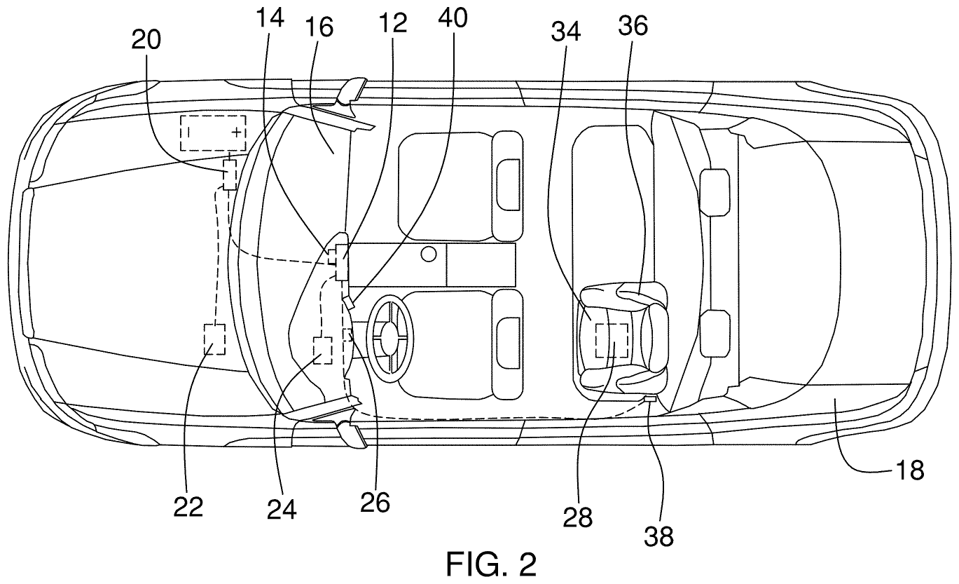

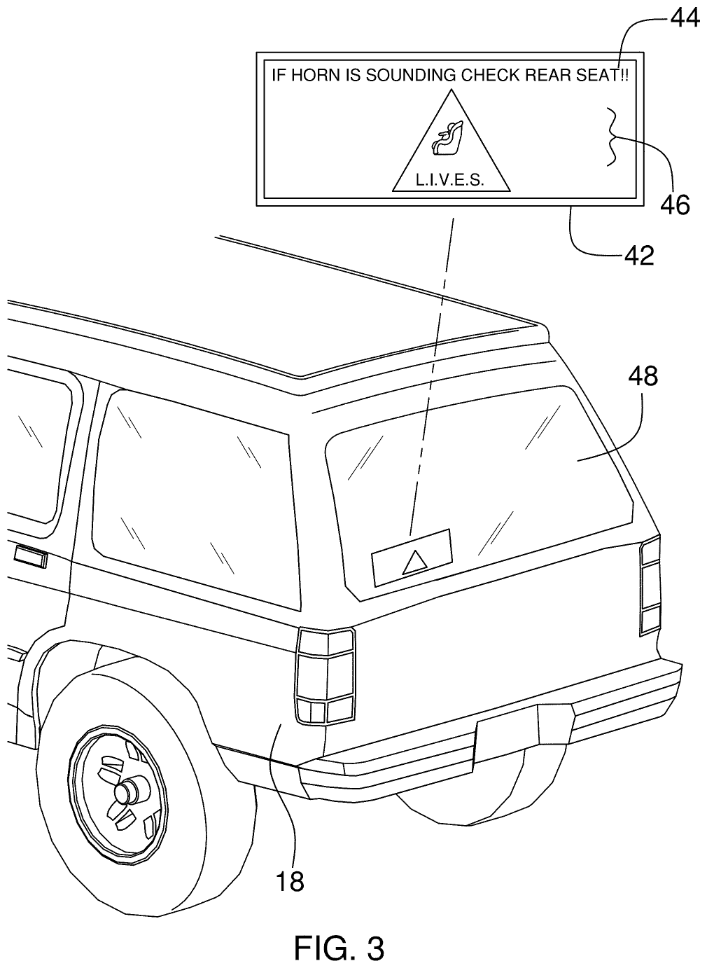

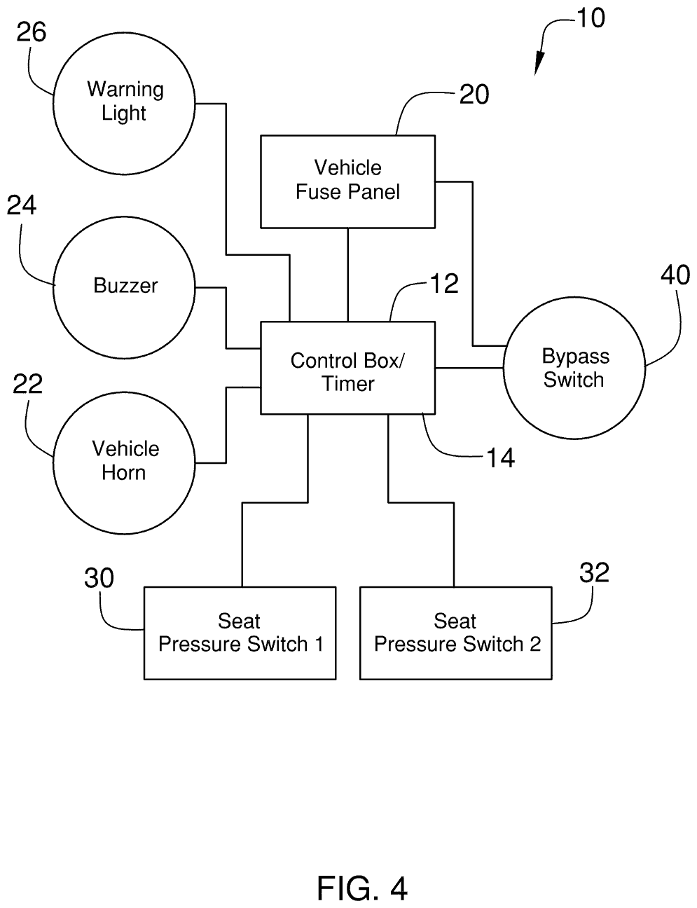

With reference now to the drawings, and in particular to FIGS. 1 through 4 thereof, a new vehicle safety device embodying the principles and concepts of an embodiment of the disclosure and generally designated by the reference numeral 10 will be described.

As best illustrated in FIGS. 1 through 4, the vehicle backseat child detection system 10 generally comprises a control box 12 having a timer 14. The control box 12 is configured to be coupled within a dashboard 16 of a vehicle 18. The control box 12 is in operational communication with a fuse panel 20 and a horn 22 of the vehicle.

A buzzer 24 is in operational communication with the control box 12 and is configured to be coupled within the dashboard 16 of the vehicle. A warning light 26 is in operational communication with the control box 12 and is configured to be coupled within the dashboard 16 of the vehicle.

At least one seat pressure switch 28 may comprise a first seat pressure switch 30 and a second seat pressure switch 32. Each seat pressure switch 28 detects the weight of a child and is in operational communication with the control box 12. Each seat pressure switch 28 is configured to be placed within a seat bottom 34 of a child seat 36. Each seat pressure switch 28 may have a seat connector coupling 38. The seat connector coupling 38 is selectively disengageable to allow removal of the child seat 36 from the vehicle 18 without removing the seat pressure switch 28.

In use, if at least one seat pressure switch 28 detects the presence of a child and the control box 12 detects the vehicle 18 has been turned off, the warning light 26 is activated and the timer 14 runs for a preset duration of time before activating the buzzer 24 and the horn 22 of the vehicle unless the child is removed. If at least one seat pressure switch 28 detects a child is placed in the child seat 36 while the vehicle 18 is off, the warning light 26 is activated and the timer 14 runs for a preset duration of time before activating the buzzer 24 and the horn 22 of the vehicle unless the vehicle 18 is turned on.

The timer 14 may be set for a preset duration of sixty seconds.

There may be a bypass switch 40 in operational communication with the control box 12 and configured to be coupled within the dashboard 16 of the vehicle. The bypass switch 40 allows the seat pressure switches 28 to detect weight without activating the buzzer 24 or the horn 22 of the vehicle. The user may thus place groceries or other items on the seat pressure switches 28 without engaging the apparatus 10.

A sticker 42 has an instruction 44 printed on a sticker front side 46 thereof to notify passersby to the significance of the horn 22 honking. The instruction 44 may read: “If horn is sounding check rear seat!”. The sticker 42 is configured to be coupled to a rear window 48 of the vehicle to be most visible in a parking lot.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A vehicle backseat child detection system comprising:
a control box, the control box having a timer, the control box being configured to be coupled within a dashboard of a vehicle, the control box being in operational communication with a fuse panel and a horn of the vehicle;
a warning light, the warning light being in operational communication with the control box and being configured to be coupled within the dashboard of the vehicle; and
at least one seat pressure switch, each seat pressure switch detecting the weight of a child and being in operational communication with the control box, each seat pressure switch being configured to be placed within a seat bottom of a child seat, wherein if one seat pressure switch detects the presence of a child and the control box detects the vehicle has been turned off the warning light is activated and the timer rims for a preset duration of time before activating the horn of the vehicle unless the child is removed, wherein if one seat pressure switch detects a child is placed in the child seat while the vehicle is off, the warning light is activated and the timer runs for a preset duration of time before activating the horn of the vehicle unless the vehicle is turned on.

2. The vehicle backseat child detection system of claim 1 further comprising a buzzer, the buzzer being in operational communication with the control box and being configured to be coupled within the dashboard of the vehicle; the buzzer being activated simultaneously with the horn of the vehicle.

3. The vehicle backseat child detection system of claim 1 further comprising a bypass switch, the bypass switch being in operational communication with the control box and being configured to be coupled within the dashboard of the vehicle, the bypass switch allowing the seat pressure switches to detect weight without activating the horn of the vehicle.

4. The vehicle backseat child detection system of claim 1 further comprising each seat pressure switch having a seat connector coupling, the seat connector coupling being selectively disengageable to allow removal of the child seat from the vehicle without removing the seat pressure switch.

5. The vehicle backseat child detection system of claim 1 further comprising the at least one seat pressure switch comprising a first seat pressure switch and a second seat pressure switch.

6. The vehicle backseat child detection system of claim 1 further comprising a sticker, the sticker having an instruction printed on a sticker front side thereof to notify passersby to the significance of the horn honking, the sticker being configured to be coupled to a rear window of the vehicle.

7. The vehicle backseat child detection system of claim 6 further comprising the instruction reading, “If horn is sounding check rear seat!”

8. A vehicle backseat child detection system comprising:
a control box, the control box having a timer, the control box being configured to be coupled within a dashboard of a vehicle, the control box being in operational communication with a fuse panel and a horn of the vehicle;
a buzzer, the buzzer being in operational communication with the control box and being configured to be coupled within the dashboard of the vehicle;
a warning light, the warning light being in operational communication with the control box and being configured to be coupled within the dashboard of the vehicle;
at least one seat pressure switch comprising a first seat pressure switch and a second seat pressure switch, each seat pressure switch detecting the weight of a child and being in operational communication with the control box, each seat pressure switch being configured to be placed within a seat bottom of a child seat, each seat pressure switch having a seat connector coupling, the seat connector coupling being selectively disengageable to allow removal of the child seat from the vehicle without removing the seat pressure switch, wherein if one seat pressure switch detects the presence of a child and the control box detects the vehicle has been turned off, the warning light is activated and the timer runs for a preset duration of time before activating the buzzer and the horn of the vehicle unless the child is removed, wherein if one seat pressure switch detects a child is placed in the child seat while the vehicle is off, the warning light is activated and the timer runs for a preset duration of time before activating the buzzer and the horn of the vehicle unless the vehicle is turned on;
a bypass switch, the bypass switch being in operational communication with the control box and being configured to be coupled within the dashboard of the vehicle, the bypass switch allowing the seat pressure switches to detect weight without activating the buzzer or the horn of the vehicle; and
a sticker, the sticker having an instruction printed on a sticker front side thereof to notify passersby to the significance of the horn honking, the instruction reading, “If horn is sounding check rear seat!”, the sticker being configured to be coupled to a rear window of the vehicle.
